(19) United States
(12) Patent Application Publication
(10) Pub. No.: US 2008/0036775 A1
(43) Pub. Date: Feb. 14, 2008

(54) METHOD FOR GENERATING CHARACTERS

(76) Inventors: Fu-Sheng Wu, Tao-Yuan Hsien (TW); Yi-Hui Huang, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/757,415

(22) Filed: Jun. 4, 2007

(30) Foreign Application Priority Data
Aug. 11, 2006 (TW) 095129579

(51) Int. Cl. G06T 11/00; G09G 5/26

(52) U.S. Cl. 345/469; 345/472.3

(57) ABSTRACT

Generating a character includes recording key points and the start and ending points of a stroke, and a stroke-generating program corresponding to the stroke drawing a fine-line structure of the stroke according to the key points and the start and ending points of the stroke. After generating the centerline structure of the stroke, the thickness of the stroke is then adjusted.

### BACKGROUND OF THE INVENTION

1. Field of the Invention

The present invention relates to a character generation method, and more particularly, to a character generation method capable of generating characters with small font size in high display quality.

2. Description of the Prior Art

At present, high quality Chinese characters are commonly generated based on a stroke-combined character technique, wherein each Chinese character is considered a structural graph formed by a plurality of strokes, where each stroke is a sub-graph formed by its individual contour. Although the variety of strokes used in forming Chinese characters is few, the length, thickness and orientation of like strokes differ based on their placement within the character. Despite these differences, the character feature of any one form of stroke, such as “-”, remains relatively constant. Thus, if the length, angle, key point(s) and stroke width(s) of one stroke can be determined separately, the contour of the stroke can be easily drawn by executing a generation program.

Basically, each stroke has corresponding data, such as key points and stroke widths, and can be drawn by a stroke generation program accordingly. The stroke generation program is written in a graphic description language, and can draw the contour of one stroke in a rectangular area according to each given key point and stroke width. Each character is a combination of individual strokes sequentially drawn in a rectangular area by executing the stroke generation program for each stroke.

Please refer to FIG. 1. FIG. 1 shows a data structure of a prior art stroke table 10. Each stroke on the stroke table 10 has a stroke ID 12 and a stroke generation program 14. The computer system draws the contour of the stroke in a rectangular area using the stroke generation program corresponding to the stroke ID and using the key point(s) and stroke width(s) parameters of the stroke.

Please refer to FIG. 2 and FIG. 3. FIG. 2 shows the contour of a stroke 20 and the position of each key point and stroke width. FIG. 3 shows a data structure 30 of the stroke 20. The stroke 20 has three key points (x1, y1), (x2, y2), (x3, y3) and two stroke widths w1, w2. The data structure 30 comprises a stroke ID (ID7) of the stroke 20, three key points and two stroke widths.

Please refer to FIG. 4. FIG. 4 shows a data structure of a prior art character description file 40. The character description file 40 is used for storing the strokes contained within the character, and the stroke ID, key points, and stroke widths of each stroke. The character description file 40 contains an index table 42 and a plurality of stroke description tables 44 for each character. The index table 42 contains a character ID (CID) for each character and the address of the corresponding stroke description table 44. The stroke description table 44 is a combination of the data structures of all strokes of a character. Like the data structure 30 shown in FIG. 3, the stroke description table 44 comprises the stroke data of all strokes: stroke IDs, key points, and stroke widths. The stroke data are arranged in a predetermined order, such as the writing sequence. When drawing a character, the computer system can locate the stroke description table 44 of the character by using the index table 42 of the stroke description file 40 as long as the character ID of the character is known. Afterward, the computer system will draw all strokes of the character one by one in a rectangular area in conjunction with the stroke table 10 and complete generating the character by filling stroke contour areas based on a contour filling program.

Please refer to FIG. 5. FIG. 5 shows a plurality of Chinese characters with a small font size generated according to the prior art character generation technique. It is obvious that character graphic quality of the displayed characters is actually not quite all right. Consequently, there is a great need for providing a special character generation method for generating small-font-size characters having high display quality.

### SUMMARY OF THE INVENTION

The present invention provides a character generation method comprising creating a stroke generation table having a plurality of stroke IDs, a plurality of corresponding stroke generation programs, and a plurality of corresponding key points including start and ending points; creating a plurality of stroke description tables, each stroke description table including a plurality of stroke data contained within each character, and each stroke datum comprising a corresponding stroke ID and a plurality of key points; fetching a corresponding stroke description table according to a character ID of a character; and generating the character according to the corresponding stroke IDs, key points, and stroke generation programs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a data structure of a prior art stroke table.

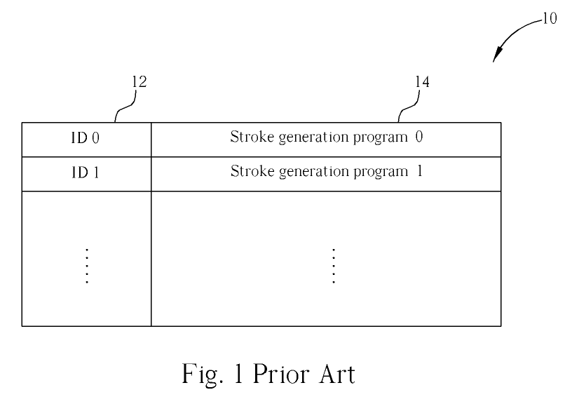

FIG. 2 shows the contour of a stroke and the position of each key point and stroke width.

FIG. 3 shows a data structure of the stroke shown in FIG. 2.

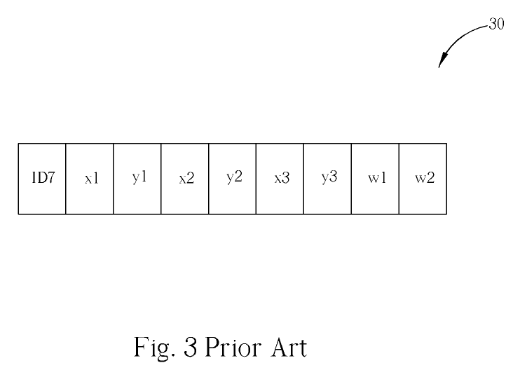

FIG. 4 shows a data structure of a prior art character description file.

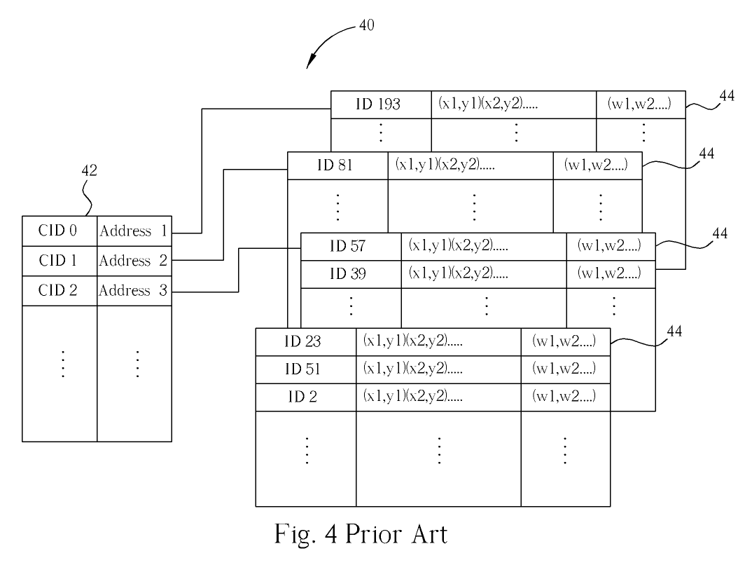

FIG. 5 shows a plurality of Chinese characters with small font size generated according to the prior art character generation technique.

FIG. 6 is a schematic diagram of generating a stroke

FIG. 7 shows the centerline structure of the stroke “-” shown in FIG. 6.

FIG. 8 is a schematic diagram of generating a stroke similar to a letter “J”.

FIG. 9 shows the centerline structure of the stroke contour shown in FIG. 8 generated according to the prior art.

FIG. 10 shows the centerline structure of the stroke contour shown in FIG. 8 generated according to the present invention.

FIG. 11 shows a plurality of Chinese characters with centerline structure generated according to the present invention.

FIG. 12 is a schematic diagram showing a stroke thickness adjustment method according to a first preferred embodiment of the present invention.

FIG. 13 is a schematic diagram showing a stroke thickness adjustment method according to a second preferred embodiment of the present invention.

FIG. 14 is a schematic diagram showing a stroke thickness adjusting method according to a third preferred embodiment of the present invention.

FIG. 15 shows a plurality of Chinese characters with small font size generated according to the first preferred embodiment of the thickness adjustment method of the present invention shown in FIG. 12.

FIG. 16 shows a plurality of Chinese characters with small font size generated according to the third preferred embodiment of the thickness adjustment method of the present invention shown in FIG. 14.

FIG. 17 is a schematic diagram showing a stroke data structure of a stroke having a stroke ID according to the present invention.

FIG. 18 shows a stroke generation table according to the present invention.

FIG. 19 shows a data structure of a character description file according to the present invention.

FIG. 20 is a flowchart illustrating one preferred embodiment of the character generation method according to the present invention.

### DETAILED DESCRIPTION

According to the present invention, the character generation method begins by generating characters having a centerline structure corresponding to filled stroke contours or unfilled stroke contours, and then adjusts a thickness of each stroke within characters to generate small font size characters with higher display quality and faster generating speed.

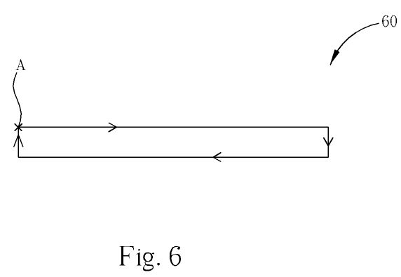

Please refer to FIG. 6. FIG. 6 is a schematic diagram of generating a stroke 60 similar to a straight line “-”. According to the prior art stroke generation program, the stroke 60 is drawn along an arrow-indicated direction from a start point A, which forms a closed contour as shown in FIG. 6.

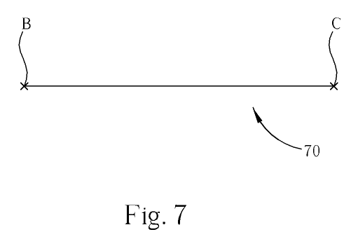

Please refer to FIG. 7. FIG. 7 shows the centerline structure 70 of the stroke 60. According to the prior art stroke generation program, the centerline structure 70 of the stroke 60 is drawn from a point B to a point C and then from the point C back to the point B, which actually forms a “pseudo” closed contour.

However, according to the stroke generation program of the present invention, the centerline structure 70 of the stroke 60 shown in FIG. 7 is drawn only from the start point B to the ending point C without a drawing from the point C back to the point B.

In a preferred embodiment of the stroke generation program of the present invention, the start point corresponds to a first key point of the stroke and the ending point corresponds to a last key point of the stroke for most of the strokes generated. However, in some other generating situations, the start and ending points for generating characters are defined manually.

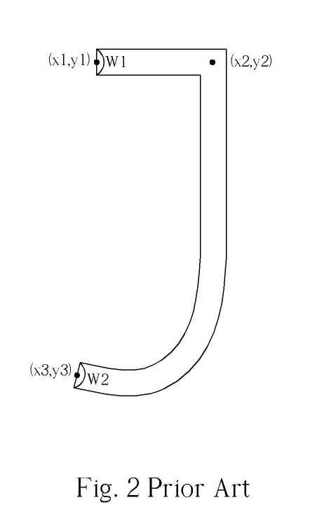

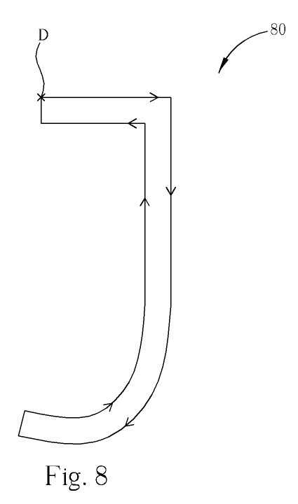

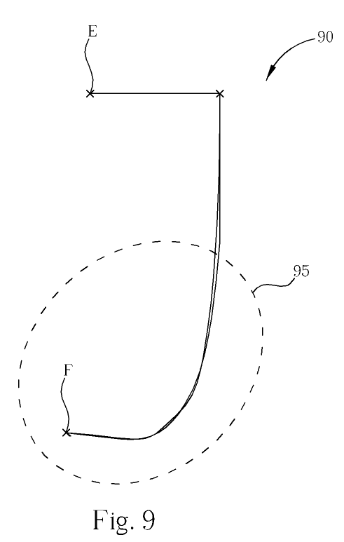

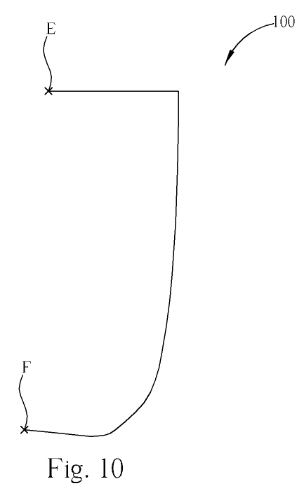

Please refer to FIG. 8 through FIG. 10. FIG. 8 is a schematic diagram of generating a stroke 80 similar to a letter “J”, which is drawn along an arrow-indicated direction from a point D. According to the prior art stroke generation program, when W1 and W2 of FIG. 2 are set to 0, a stroke with no width is generated, as shown in FIG. 9. When the widths W1 and W2 are set to 0, a single line is generated, which decreases the curving effect, as shown in a region 95 in FIG. 9. In the region 95, the curves are drawn in different directions, and do not overlap uniformly, which decreases the quality of the single line. By setting the start point and the end point, e.g. points E and F of FIG. 9, to obtain the single line from the point E to the point F, the single line quality can be improved, as shown in FIG. 10. The method described above is the simplest method for obtaining the single line, though other methods are available, such as taking the centerline of FIG. 8 directly.

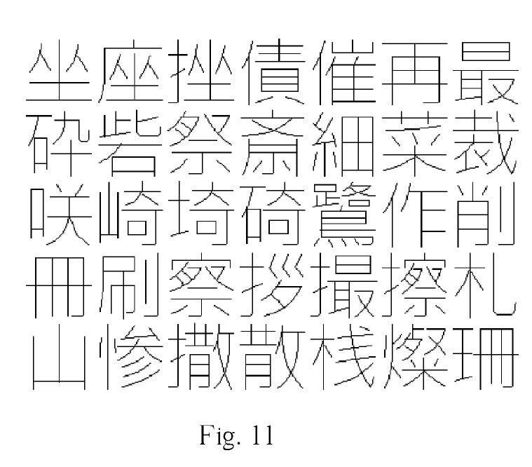

Please refer to FIG. 11. FIG. 11 shows a plurality of Chinese characters with centerline structure generated according to the present invention. It is obvious that the centerline structures of the displayed characters are all ideal. Thereafter, characters with desirable typeface can be generated by adjusting the thickness of each centerline stroke within the characters.

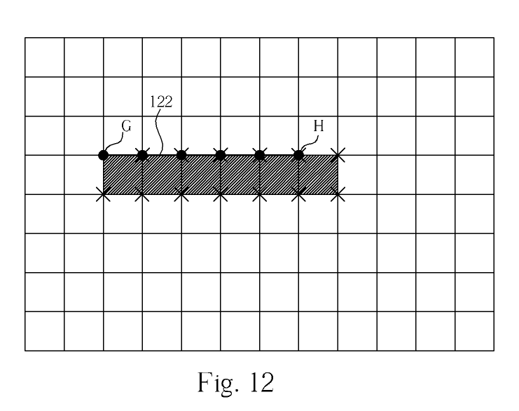

Please refer to FIG. 12. FIG. 12 is a schematic diagram showing a stroke thickness adjustment method according to a first preferred embodiment of the present invention. The original centerline stroke is shown as a thick line 122 stretching from a point G to a point H. All the points in the thick line 122 are symbolized as solid circles. The stroke thickness is adjusted by expanding each point in the thick line 122 to a rightward adjacent point, to a downward adjacent point, and to a diagonal point. All the expanding points for stroke thickness adjustment are symbolized as crosses. The expanding direction and the expanding thickness can be adjusted according to the font size of the characters.

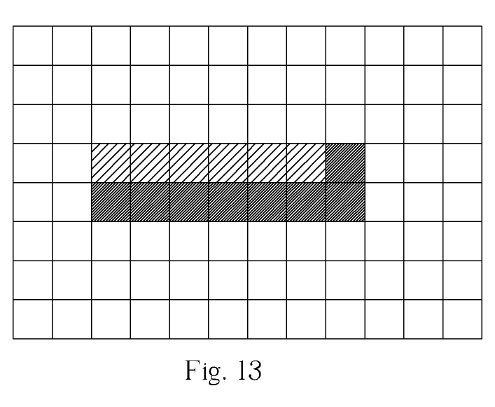

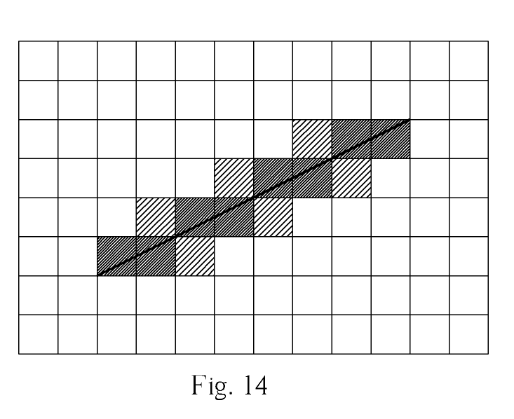

Please refer to FIGS. 13 and 14, which are diagrams of adjusting stroke thickness according to a second embodiment and a third embodiment of the present invention, respectively. In the second embodiment, thickening areas are generated below and to the right of the original line to increase the thickness of the stroke. As shown in FIG. 13, the original line is indicated by light squares, whereas the thickening areas below and to the right of the original line are indicated by dark squares. Please note that use of light and dark squares in FIG. 13 is only for indicating that the lighter squares are generated based on the darker squares. In practice, the thickened line, i.e. the light squares and the dark squares, will have uniform color when displayed.

In the third embodiment, a single line passes through square regions, as shown in FIG. 14. To thicken the single line, a shortest distance between each square region and the single line is calculated. The shortest distance could be calculated from a number of different points on each square region, e.g. a center or a corner. Based on the shortest distance between the square region and the single line, a gray level is assigned to the square region. If the square region is close to the single line, i.e. within a predetermined distance threshold, the square region is assigned a relatively darker gray level. If the square region is within a second predetermined distance threshold that is further from the single line, the square region is assigned a lighter gray level. Of course, the number of thresholds and corresponding gray levels is not a limitation of the present invention. The darkness of the square region preferably decreases the further away the square is from the single line. Of course, the use of a square-shaped region is also not a limitation of the present invention, and other shapes could be used, such as rectangles, triangles, or individual pixels. Further, size of each square-shaped region is also not limited.

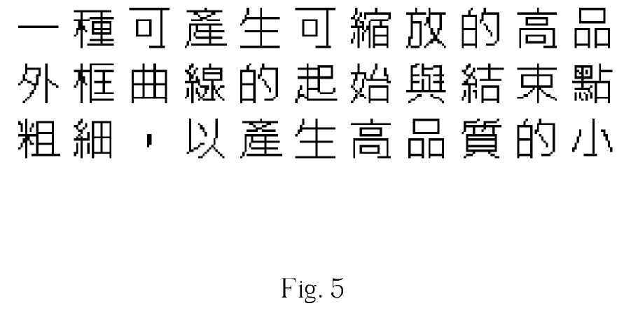

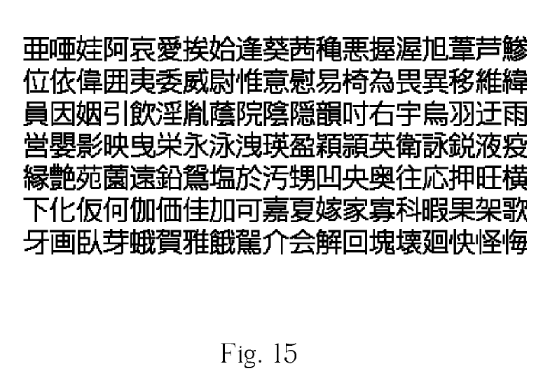

Please refer to FIG. 15. FIG. 15 shows a plurality of Chinese characters with small font size generated according to the first preferred embodiment of the thickness adjustment method of the present invention shown in FIG. 12. It is obvious that character graphic quality of the displayed characters is actually better than the quality of those shown in FIG. 5 according to the prior art technology. Consequently, the character generation method of the preferred embodiment shown in FIG. 12 is suitable for generating small-font-size characters having high display quality.

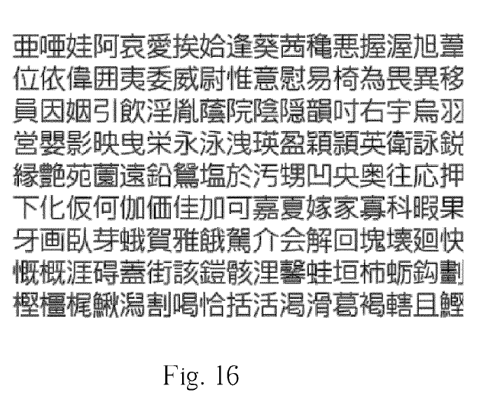

Please refer to FIG. 16. FIG. 16 shows a plurality of Chinese characters with small font size generated according to the third preferred embodiment of the thickness adjustment method of the present invention shown in FIG. 14. It is obvious that character graphic quality of the displayed characters is also better than the quality of those shown in FIG. 5 according to the prior art technology. Consequently, the character generation method of the preferred embodiment shown in FIG. 14 is also suitable for generating small-font-size characters having high display quality.

In summary, the character generation method of the present invention is capable of generating small-font-size characters having high display quality.

When displaying a plurality of characters on a display system, the display system is able to judge font size of the characters to be displayed. If the characters to be displayed are judged to be of a large font size, the aforementioned prior art character generation method can be utilized to generate the plurality of characters on a display system. If the characters to be displayed are judged to be of a small font size, the character generation method of the present invention can be utilized to generate the plurality of characters on the display system for better display quality of small font size characters.

Taking the Big-5 character set commonly used in Taiwan as an example, which has 13060 characters. The 13060 characters in the Big-5 character set can be represented by approximately 300 strokes. Each stroke uses 4 bytes to store the start point and the end point, for a total of about 1.2 KB. According to the prior art, a typical character description file requires about 1.2 MB (mega-byte) of memory space. The character generation method of the present invention requires an additional 1.2 KB of memory space for generating small font size characters with high display quality. However, the additional 1.2 KB of memory space is actually only a small amount of memory space compared to the typically required 1.2 MB of memory space.

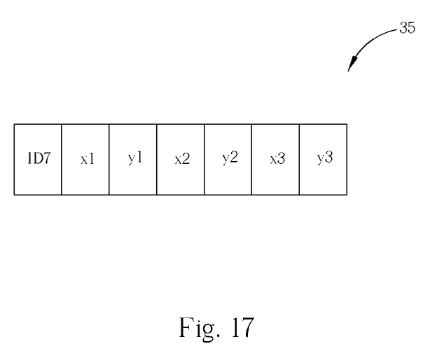

Please refer to FIG. 17 through FIG. 19. FIG. 17 is a schematic diagram showing a stroke data structure 35 of a stroke having a stroke ID (ID7) according to the present invention. The stroke data structure 35 comprises only three key points (x1, y1), (x2, y2), (x3, y3) without any data on stroke widths.

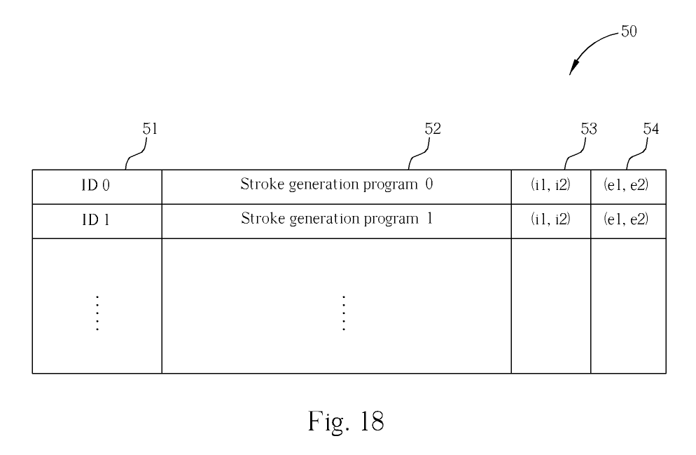

FIG. 18 shows a stroke generation table 50 according to the present invention. Each stroke on the stroke generation table 50 comprises a stroke ID 51, a stroke generation program 52, a start point (i1, i2) 53, and an ending point (e1, e2) 54. The computer system draws the centerline structure of the stroke in a rectangular area using the stroke generation program corresponding to the stroke ID and using the key points of the start point (i1, i2) and the ending point (e1, e2) as parameters of the stroke.

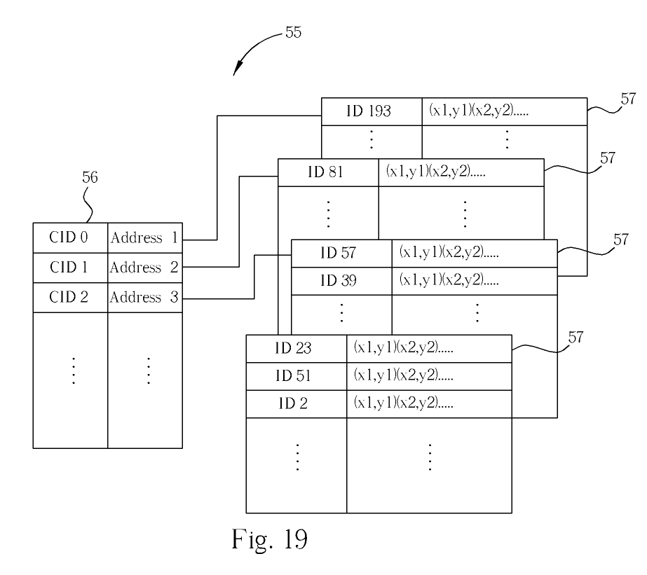

FIG. 19 shows a data structure of a character description file 55 according to the present invention. The character description file 55 is used for storing the strokes contained within the character, and the stroke ID and key points of each stroke. The character description file 55 contains an index table 56 and a plurality of stroke description tables 57 for each character. The index table 56 contains a character ID (CID) for each character and the address of the corresponding stroke description table 57. The stroke description table 57 is a combination of the data structures of all strokes of a character.

Like the data structure 35 shown in FIG. 17, the stroke description table 57 comprises the stroke data of all strokes such as stroke IDs and key points. The stroke data are arranged in a predetermined order, such as the writing sequence. When drawing a character, the computer system can locate the stroke description table 57 of the character by using the index table 56 of the stroke description file 55 as long as the character ID of the character is known. Afterward, the computer system will draw all strokes of the character in a rectangular area in conjunction with the stroke generation table 50. The drawing procedure comprises generating characters with centerline structure and adjusting a thickness of each stroke.

Based on the aforementioned data structure of the present invention, there is another alternative to reduce the memory space required for character generation. That is, all the characters are generated based on the character generation method of the present invention regardless of the character font size. In this situation, the data of the key points of the stroke concerning the stroke widths W1 and W2 shown in the data structure 30 can be omitted and the required memory space is reduced. Accordingly, the required memory space can be reduced from 1.2 MB of the prior art to approximately 1.0-1.1 MB.

Moreover, the stroke generation method of the present invention is utilized only to generate a single curve as a centerline structure instead of a closed contour of the prior art. Therefore, the computational complexity for character generation can be reduced and the character generating speed can be increased significantly.

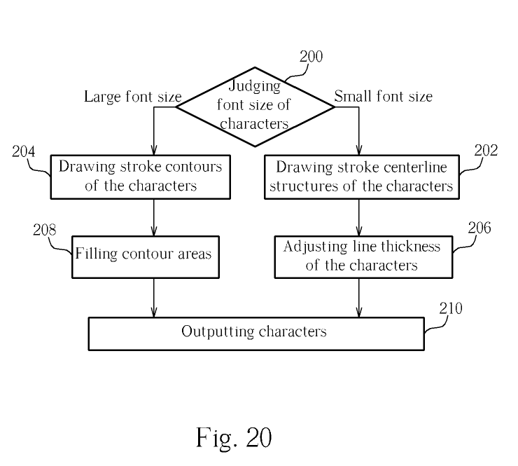

Please refer to FIG. 20. FIG. 20 is a flowchart illustrating one preferred embodiment of the character generation method according to the present invention. The preferred character generation method comprises the following steps:

Step 200: judge font size of the characters to be generated; if the characters are judged to have a large font size, perform step 204; if the characters are judged to have a small font size, perform step 202;

Step 202: fetch a corresponding stroke description table 57 according to a character ID CID 56, draw strokes having a centerline structure according to the start and ending points and stroke generation program 52 with the aid of the stroke generation table 50, perform step 206;

Step 204: draw character contours according to the prior art technology, perform step 208;

Step 206: adjust the thickness of each of the strokes contained within one character, perform step 210;

Step 208: fill character contours by a filling program, perform step 210;

Step 210: output characters generated.

In another preferred embodiment of the character generation method according to the present invention, the steps 200, 204, and 208 can be omitted, and the method for generating characters can be based on the steps 202, 206, and 210, which means that all the characters are generated based on the character generation method of the present invention regardless of the character font size.

In summary, the method of the present invention is able to generate small font size characters with higher display quality and faster generating speed. In addition, a compound character generation method based on the prior art technology and the present invention can be achieved with a small amount of extra memory space. Furthermore, if all the characters are generated according to the present invention method, the required memory space for character generation can be reduced to be less than that of the prior art.

Those skilled in the art will readily observe that numerous modifications and alterations of the device and method may be made while retaining the teachings of the invention.

What is claimed is:

1. A method for generating characters, comprising:
creating a stroke generation table, the stroke generation table comprising a plurality of stroke IDs, a plurality of corresponding stroke generation programs, and a plurality of corresponding key points, the plurality of key points comprising start and ending points;
creating a plurality of stroke description tables, each stroke description table comprising a plurality of stroke data contained within each character, and each stroke datum comprising a corresponding stroke ID and a plurality of key points;
fetching a corresponding stroke description table according to a character ID of a character; and
generating the character according to the corresponding stroke IDs, key points, and stroke generation programs.

2. The method of claim 1, further comprising:
drawing a stroke having a centerline style for a filled stroke contour corresponding to a stroke ID according to the start and ending points of the stroke, wherein the start point is a first key point and the ending point is a last key point of the stroke.

3. The method of claim 1, further comprising:
drawing a stroke having a centerline style for an unfilled stroke contour corresponding to a stroke ID according to the start and ending points of the stroke, wherein the start point is a first key point and the ending point is a last key point of the stroke.

4. The method of claim 1, further comprising:
adjusting a thickness of each of the strokes contained within one character.

5. The method of claim 4, wherein the method of adjusting the thickness of each of the strokes contained within one character comprises:
expanding each point of the strokes having the centerline style within one character to adjacent points along a plurality of directions.

6. The method of claim 4, wherein the method of adjusting the thickness of each of the strokes contained within one character comprises:
drawing solid circles centered at each point of the strokes having the centerline style within one character for expanding to surrounding points.

7. The method of claim 4, wherein the method of adjusting the thickness of each of the strokes contained within one character comprises:
widening the thickness of each stroke having the centerline style within one character along a predetermined direction with a decreasing gray scale.
